(19) United States
(12) Patent Application Publication
(10) Pub. No.: US 2023/0057416 A1
(43) Pub. Date: Feb. 23, 2023

(54) Electro-Rheological Fluid and Cylinder Device

(71) Applicant: Hitachi Astemo, Ltd., Hitachinaka-shi, Ibaraki (JP)

(72) Inventors: Satoshi ISHII, Tokyo (JP); Mina AMO, Tokyo (JP)

(21) Appl. No.: 17/793,557

(22) PCT Filed: Jan. 26, 2021
(86) PCT No.: PCT/JP2021/002652

§ 371 Date: Jul. 18, 2022

(30) Foreign Application Priority Data
Feb. 10, 2020 (JP) 2020-020323

(51) Int. Cl. C10M 169/04; C10M 149/14; F16F 9/53; F16F 9/18

(52) U.S. Cl. CPC C10M 169/041; C10M 149/14; F16F 9/185; F16F 9/532; C10M 2203/003; C10M 2217/045; C10N 2040/08

(57) ABSTRACT

To provide an electro-rheological fluid and a cylinder device, which each can achieve both high heat resistance and a high ER effect. The electro-rheological fluid (300) of the present invention includes a fluid (30) and polyurethane particles (31) containing metal ion. The polyurethane particles (31) are each composed of polyol and two or more types of isocyanates. A hard segment ratio of the polyurethane particle (31) is 13 to 34%.

### TECHNICAL FIELD

The present invention relates to an electro-rheological fluid and a cylinder device.

### BACKGROUND ART

A vehicle typically has a cylinder device to damp vibration in a short time during travelling for improving ride quality or running stability. A known example of such a cylinder device includes a shock absorber using an electro-rheological fluid (ERF) to control damping force depending on a road surface condition, for example. Although ERF containing particles (particle-dispersed ERF) is typically used in the cylinder device, material or a structure of the particle is known to affect ERF performance and in turn affect performance of the cylinder device.

Patent Literature 1 discloses ERF containing polyurethane particles that each contain one or more electrolyte and are dispersed in a silicone oil, in which main ingredients of the polyurethane are polyether polyol and toluene diisocyanate (TDI), and the electrolyte contained in the polyurethane particle includes organic ion such as acetic acid ion or a stearic acid ion and substantially includes no inorganic ion.

### CITATION LIST

### Patent Literature

Patent Literature 1: Japanese Patent No. 6108319

### SUMMARY OF INVENTION

### Technical Problem

In case of the above particle-dispersed ERF, rheology change (ER effect) of the ERF due to voltage application is known to be affected by the magnitude of a dielectric constant of the contained particle. Although an existing particle having a large dielectric constant, such as titanium oxide particle, is expected, since the particle may cause abrasion due to contact of such a hard particle to a liquid contact part in a component, the particle must be carefully used. Specifically, although a flexible resin particle is desirably used for exhibition of a sufficient ER effect, since the resin particle has a low dielectric constant compared with oxide particles, a breakthrough is necessary.

In the ERF using the polyurethane containing the electrolyte as described in Patent Literature 1, ion conduction within the polyurethane causes uneven distribution of ions within the particle, which increases polarization of the polyurethane particles compared with polarization caused by a dielectric constant of only the resin. This enables enhancement of the ER effect.

At this time, conductivity of ions (ionized electrolyte) within the particle is important. To achieve sufficient ion conductivity, polyether polyol having a flexible skeleton and toluene diisocyanate (TDI), which is most versatile and does not excessively increase hardness of the polyurethane, are used as materials of the polyurethane. However, the polyurethane in this case has a flexible molecular skeleton and thus has insufficient heat resistance for an in-vehicle cylinder device and cannot maintain sufficient durability over the product life, and thus desired damping force may not be achieved. In other words, the ER effect or the damping force is in a trade-off relationship with mechanical strength or heat resistance, and thus balancing between the two is one problem. It is therefore desired to develop ERF that fundamentally solves the above problem.

An object of the invention, which is made in light of such circumstances, is to provide an electro-rheological fluid and a cylinder device, which each have sufficient heat resistance while exhibiting a large ER effect.

### Solution to Problem

To achieve the object, one aspect of the invention is an electro-rheological fluid characterized by including a fluid and polyurethane particles containing metal ion, where the polyurethane particles are each composed of polyol and two or more types of isocyanates, and a hard segment ratio of the polyurethane particle is 13 to 34%. The hard segment ratio means an index indicating a ratio of an isocyanate called hard segment contributing to heat resistance and strong toughness. Detailed definition is described later.

To achieve the object, another aspect of the invention is a cylinder device characterized by including a piston rod, an inner casing in which the piston rod is inserted, an electro-rheological fluid provided between the piston rod and the inner casing, and a voltage application unit that applies a voltage to the electro-rheological fluid. The electro-rheological fluid includes a fluid and polyurethane particles containing metal ion. The polyurethane particles are each composed of polyol and two or more types of isocyanates. A hard segment ratio of the polyurethane particle is 13 to 34%.

A more specific configuration of the invention is described in claims.

### Advantageous Effects of Invention

According to the invention, it is possible to provide an electro-rheological fluid and a cylinder device, which each have sufficient heat resistance while exhibiting a large ER effect.

Other problems, configurations, and effects are more clarified by the following description of an embodiment.

### BRIEF DESCRIPTION OF DRAWINGS

FIG. 1 is a schematic diagram illustrating one example of an electro-rheological fluid of the invention.

FIG. 2 is a schematic diagram illustrating a constitution of the polyurethane particle in FIG. 1.

FIG. 3 is a schematic longitudinal section diagram illustrating one example of a cylinder device of the invention.

### DESCRIPTION OF EMBODIMENT

One embodiment of the invention is now described with reference to drawings.

### Electro-Rheological Fluid

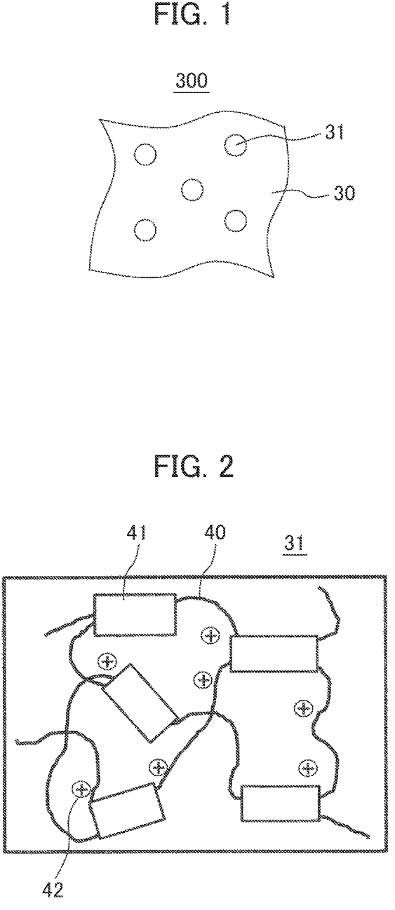

FIG. 1 is a schematic diagram illustrating one example of an electro-rheological fluid of the invention. As illustrated in FIG. 1, an electro-rheological fluid (ERF) 100 of the invention includes a fluid 30 and polyurethane particles 31 containing metal ion. The fluid 30 is a dispersion medium including an insulative medium (base oil), and the polyurethane particles 31 correspond to a dispersoid dispersed in the base oil. In other words, the ERF corresponds to a suspension in which the polyurethane particles 31 are dispersed in the base oil. The polyurethane particle 31 containing metal ion is a substance that forms a particle structure by a voltage applied thereto and thus exhibits an ER effect of increasing fluid viscosity. The ER effect varies depending on a type of the metal ion contained in the polyurethane particle 31.

FIG. 2 is a schematic diagram illustrating a constitution of the polyurethane particle in FIG. 1. As illustrated in FIG. 2, the polyurethane particle 31 is configured of a soft segment 40 of high-molecular-weight diol and a hard segment 41 having a high urethane group concentration. The soft segment 40 contributes to ion conduction in the particle through large thermal molecular motion, and the hard segment contributes to heat resistance or strong toughness of the particle. In other words, the ER effect is affected by a material composition of the soft segment, while heat resistance is affected by a material composition of the hard segment, and each is also affected by a ratio between the soft segment and the hard segment.

As described above, optimizing the material composition of the hard segment and a proportion of the hard segment in the particle can improve heat resistance of the particle and in turn improve heat resistance of the ERF. When the ratio of the soft segment to the hard segment meets some condition, an effective ion conduction path is formed in the particle and ion conductivity is expected to be improved. Since many examples of improvement in ion conductivity due to a phase separation structure have been reported in solid ion conductors such as an electrolyte used in a lithium battery or a fuel cell, similar effects can be expected in the present system.

The polyurethane particle 31 is composed of polyol and isocyanate. The ERF of the invention includes two or more types of isocyanates as the main ingredients of the hard segment to form an appropriate phase separation structure while increasing the hard segment ratio in the polyurethane particle 31. Such use of two or more types of isocyanate ingredients can provide ERF having high heat resistance and exhibiting a large ER effect.

The ratio of the hard segment 41 in the polyurethane particle 31 can be calculated through processing such as binarization of a picture obtained by imaging differences in hardness over a cross section of the particle in phase mode measurement by an atomic force microscopy (AFM). In the invention, however, the hard segment ratio is defined as follows.

$$\begin{matrix}\left(\text{Hard segment ratio: \%}\right) = \\ \left(\text{isocyanate mass: g}\right) / \\ \left(\text{total mass of polyurethane ingredients: g}\right)\end{matrix}$$

(Hard segment ratio: %) = (isocyanate mass: g) / (total mass of polyurethane ingredients: g)

In the invention, the hard segment ratio is preferably 13 to 34%, more preferably 13 to 25% in light of the ER effect. The ratio of less than 13% results in insufficient heat resistance. The ratio of more than 34% significantly decreases the amount of the soft segment, which may lead to an insufficient ER effect.

Three or more types of isocyanates may compose the polyurethane particle 31. Any type of isocyanate may be used without limitation as long as the ratio of the hard segment falls within the above range. However, if molecular weights of the two or more types of the isocyanates are at the same level, since the isocyanates are expected to occupy similar volumes in a form of the hard segment within the synthesized polyurethane, the isocyanates used in the invention need to have different molecular weights. This is because since the molecular weights are at the same level, hard segment concentration does not increase even if two or more types of isocyanates are used. Specifically, one molecular weight is desirably 1.4 times or more different from another molecular weight.

Further, a high-molecular-weight component is preferably used because the soft segment is more clearly separated from the hard segment thereby. Meanwhile, an increase in ratio of the isocyanate having a large molecular weight increases hardness of the polyurethane particle 31 and decreases ion conductivity, which may lead to a reduction in ER effect. The mixing ratio between two or more types of isocyanates having different molecular weights is therefore important.

Examples of the isocyanate used in the polyurethane particle 31 include diisocyanate. The diisocyanate is roughly classified into two types, a type having an aliphatic skeleton and a type having an aromatic skeleton.

Examples of the diisocyanate having the aliphatic skeleton include hexamethylene diisocyanate (HDI), isophorone diisocyanate (IPDI), hydrogenated xylylene diisocyanate, and dicyclohexylmethane diisocyanate.

Examples of the diisocyanate having the aromatic skeleton include toluene diisocyanate (TDI), diphenylmethane diisocyanate (MDI), polymeric MDI (pMDI), tolidine diisocyanate, naphthalene diisocyanate (NDI), xylylene diisocyanate (XDI), tetramethyl-m-xylylene diisocyanate, and dimethyl-biphenyl diisocyanate (BPDI).

Modified isocyanates, such as adduct, isocyanurate, biuret, uretdione, and blocked isocyanate, can also be used. The modified isocyanates include TDI-based isocyanate, MDI-based isocyanate, HDI-based isocyanate, and IPDI-based isocyanate, and a modified product exists for each of such modified isocyanates.

Examples of a material usable as polyol, which is the other main ingredient composing the polyurethane particle 31, include polyether polyol, polyester polyol, polycarbonate polyol, vegetable oil polyol, and castor oil polyol. As with isocyanate, any other polyol can be used in the invention as long as that polyol achieves an appropriate hard segment ratio. The mass ratio of polyol to isocyanate (polyol/isocyanate) is preferably 28 to 51%. The mass ratio is more preferably 30 to 40% in light of achieving both the ER effect and heat resistance at a high level.

A polyurethan particle composed of materials other than the above materials is also within the scope of the invention as long as two or more types of isocyanates are used so that the hard segment ratio is within an appropriate range. However, since a clear phase separation structure is known to be formed in case of using the aromatic isocyanate compared with a case of using the aliphatic isocyanate, the aliphatic isocyanate is preferably used to achieve both the ER effect and heat resistance at a high level.

In particular, a highly versatile diisocyanate, such as, for example, TDI or diphenylmethane diisocyanate (MDI), is further preferably used. In such a case, the mass ratio of TDI to MDI (MDI/TDI) is preferably 0.13 to 4. In particular, in case of using the polymeric MDI (pMDI), which particularly has a high molecular weight, among MDIs, the mass ratio of pMDI to TDI (diphenylmethane diisocyanate / toluene diisocyanate) is preferably 0.13 to 0.6. As described above, the mass ratio of polyol to isocyanate (polyol/isocyanate) is preferably 28 to 51% .

Further, the polyurethane particle 31 contained in the electro-rheological fluid of the invention characteristically has a lower electric resistance than typical polyurethane used as an insulating material so as to serve as the ERF. Specifically, the typical polyurethane used as an insulating material has an electric resistance (volume resistivity) of about 10¹³ to 10¹⁵ Ω·cm at 20° C. In the invention, a current value is measured at the same time when the ER effect of the ERF is measured. Electric resistance is calculated from an applied voltage and the current value according to Ohm’s law. The silicone oil as a medium of the ERF has an electric resistance of about 10¹⁵ Ω·cm. Since the ERF of the invention has an electric resistance of 10¹⁰ to 10¹³ Ω·cm, the polyurethane particle 31 contained in the ERF is larger than 10¹⁰ to 10¹³ Ω·cm and thus larger than typical polyurethane.

Although any type of ion may be contained in the ERF particle without limitation as long as the ion can be contained in the particle and exhibits the ERF effect, a cation desirably includes at least one alkali metal. In particular, for example, lithium ion and potassium ion each having a small ion radius are further desirable. A smaller ion radius leads to higher displacement response at voltage application. In addition, such a smaller ion radius desirably allows alkaline earth metal ion and transition metal ion, specifically barium ion, magnesium ion, zinc ion, and copper ion, to be easily coordinated to a molecular chain and easily retained in an inner layer of the particle.

Any type of anion, such as acetate ion, sulfate ion, nitrate ion, phosphate ion, and halogen ion, can also be used without limitation. Halogen ion is particularly preferable in light of ease of dissociation. If a wetted part has a low corrosion resistance, an organic anion having a low corrosivity is desirably used. However, any material can be used in the invention without being limited to the above materials as long as the material can be encapsulated in the particle and is ionized to function as the ERF.

Considering response and magnitude of an electro-rheological effect, the average particle diameter of the polyurethane particles 31 is preferably 0.1 to 10 um in light of mobility of the particle and viscosity increase width. The diameter of less than 0.1 µm causes agglomeration of particles 28, resulting in a reduction in workability in manufacturing. The diameter of more than 10 µm reduces displacement response. The average particle diameter of the particles 28 is more preferably within a range from 3 to 7 µm.

Concentration of the polyurethane particles 31 in the electro-rheological fluid 300 is preferably 30 to 70 mass% in light of magnitude of the electro-rheological effect and base viscosity. The concentration of the particles 28 of less than 30 mass% results in an insufficient ER effect. The concentration of more than 70 mass% increases the base viscosity and reduces viscosity increasing rate during voltage application, resulting in a reduction in variation range of damping force of a cylinder device. The concentration is more preferably in a range from 40 to 60 mass% to allow the ER effect to be exhibited.

Any type of dispersion medium may be used as the fluid 30 without limitation as long as the dispersion medium can disperse the polyurethane particles 31. Specifically, mineral oil such as silicone oil, paraffin oil, and naphthenic oil can be used. Viscosity of the fluid 30 contributes to viscosity and displacement response of the ERF 300 and is thus preferably 50 mm²/s or less, more preferably 10 mm²/s or less.

A material composition (including polyol and isocyanate) of the polyurethane particle 31 contained in the ERF can be identified by the following method. A monomer as a decomposed product of the polyurethane particle 31 is identified by pyrolysis GC/MS and ¹H_NMR of a hydrolysate, thereby a material composition of the components of the polyurethane, i.e., polyol, isocyanate, and another additive, can be identified.

### Cylinder Device

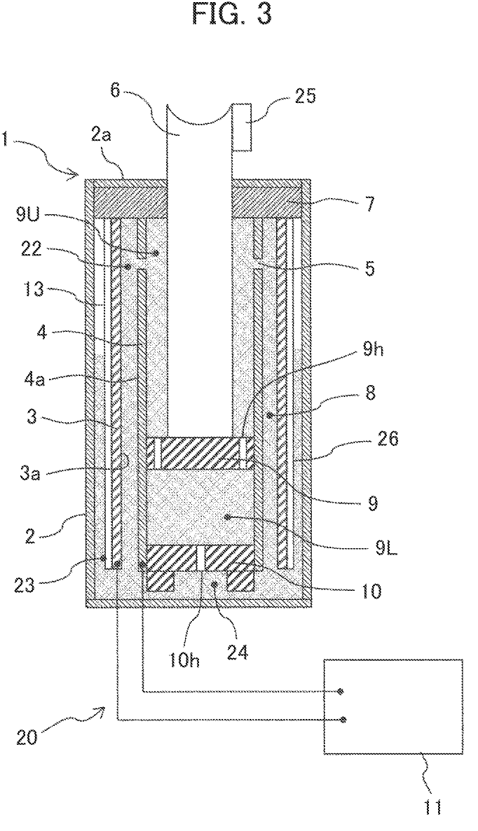

A cylinder device of the invention is now described. FIG. 3 is a schematic longitudinal section diagram illustrating one example of the cylinder device of the invention. A cylinder device 1 is typically provided one for each wheel of a vehicle, and relaxes impact and vibration between a body and an axle of a vehicle. In the cylinder device 1 illustrated in FIG. 1, a head provided at one end of a rod 6 is fixed to a body side of the vehicle (not shown), and the other end thereof is inserted in a base shell 2 and fixed to an axle side of the vehicle. The base shell 2 is a cylindrical member configuring a shell of the cylinder device 1, and contains the ERF 8 of the invention enclosed therein.

The cylinder device 1 has various main components in addition to the rod 6, such as a piston 9 provided at an end of the rod 6, an outer casing 3, an inner casing (cylinder) 4, and a voltage application unit 20. The rod 6, the inner casing 4, the outer casing 3, and the base shell 2 are coaxially disposed.

As illustrated in FIG. 1, the rod 6 has the piston 9 at its end on a side where the rod 6 is inserted in the base shell 2. The voltage application unit 20 includes an electrode (outer electrode 3a) provided on an inner circumferential surface of the outer casing 3, an electrode (inner electrode 4a) provided on an outer circumferential surface of the inner casing 4, and a controller 11 that applies a voltage between the outer electrode 3a and the inner electrode 4a.

The outer electrode 3a and the inner electrode 4a are each directly in contact with the ERF 8. Hence, a material, which is less likely to be electrolytically corroded, or corroded, by an ingredient contained in the ERF 8, is desirably used as a material of the outer electrode 3a and a material of the inner electrode 4a. Although a steel pipe or the like can be used as the material of the outer electrode 3a and of the inner electrode 4a, for example, a stainless steel pipe or a titanium pipe can be desirably used. In addition, the material may include a material, in which a coating of metal to be hardly corroded is formed by plating or resin layer formation on a surface of a metal to be easily corroded to improve corrosion resistance.

The rod 6 penetrates the upper end plate 2a for the inner casing 4, and the piston 9 provided on the lower end of the rod 6 is disposed in the inner casing 4. An oil seal 7 is provided under the upper end plate 2a of the base shell 2 to prevent leakage of the ERF 8 enclosed in the inner casing 4.

Examples of a usable material of the oil seal 7 include a rubber material such as nitrile rubber and fluoro-rubber. The oil seal 7 is in direct contact with the ERF 8. Hence, a material having a hardness equal to or higher than hardness of the particle 28 contained in the ERF 8 is desirably used as a material of the oil seal 7 to prevent the oil seal 7 from being damaged by the contained particle. In other words, a material having a hardness equal to or lower than hardness of the oil seal 7 is preferably used as a material of the particle 28 contained in the ERF 8.

The piston 9 is vertically slidably fitted in the inside of the inner casing 4 in an inserted manner, and the inside of the inner casing 4 is partitioned by the piston 9 into a lower piston room 9L and an upper piston room 9U. The piston 9 has a plurality of vertical through-holes 9h provided at an equal interval in a circumferential direction. The lower piston room 9L is in communication with the upper piston room 9U via the through-holes 9h. Each through-hole 9h has a check valve so that the ERF 8 flows through the through-hole in one direction.

The upper end of the inner casing 4 is closed by the upper end plate 2a of the base shell 2 via the oil seal 7. A body 10 exists at the lower end of the inner casing 4. As with the piston 9, the body 10 has a through-hole 10h and is in communication with the piston room 9L via the through-hole 10h.

The inner casing 4 has, near the upper end thereof, a plurality of horizontal holes 5 that are radial through-holes provided at an equal interval in a circumferential direction. As with the inner casing 4, the upper end of the outer casing 3 is closed by the upper end plate 2a of the base shell 2 via the oil seal 7 while the lower end thereof is opened. The horizontal holes 5 allow the upper piston room 9U defined by the inside of the inner casing 4 and a rod-like portion of the rod 6 to be in communication with a channel 22 defined by the inside of the outer casing 3 and the outside of the inner casing 4. The channel 22 is in communication, at its lower end, with a channel 23 defined by the inside of the base shell 2 and the outside of the outer casing 3 and with a channel 24 defined by the body 10 and a bottom plate of the base shell 2. The inside of the base shell 2 is filled with the ERF 8, and an upper space between the inside of the base shell 2 and the outside of the outer casing 3 is filled with an inert gas 13.

During travelling of a vehicle on an irregular travelling surface, the rod 6 expands and contracts along the inner casing 4 along with vibration of the vehicle. Such expansion and contraction of the rod 6 along the inner casing 4 changes each of volumes of the lower piston room 9L and the upper piston room 9U.

An undepicted vehicle body has an acceleration sensor 25. The acceleration sensor 25 detects acceleration of the vehicle body, and outputs a detected signal to the controller 11. The controller 11 determines a voltage to be applied to an electro-rheological fluid 8 based on the signal from the acceleration sensor 25, for example.

The controller 11 calculates a voltage to generate necessary damping force based on the detected acceleration, applies the voltage to between electrodes based on the calculation result, and thus allows the electro-rheological effect to be exhibited. Once the controller 11 applies the voltage, viscosity of the ERF8 varies according to the voltage. The controller 11 adjusts the voltage to be applied based on the acceleration and thus controls damping force of the cylinder device 1 to improve ride quality of the vehicle.

The cylinder device of the invention uses the ERF 8 of the invention, and thus can achieve both high heat resistance and a high ER effect. It is therefore possible to provide a cylinder device that is only slightly changed in damping force even after being subjected to a long heat load.

### EXAMPLES

Although the invention is now specifically described with Examples and comparative examples, the invention should not be limited to the following Examples.

### Production of Electro-Rheological Fluids of Examples 1 to 5

A method for producing ERF of Example 1 is described as follows. LiCl, ZnC12, polyether polyol, an emulsifier, and silicone oil were mixed and formed into an emersion by a homogenizer. Subsequently, a mixed curing agent, which was a mixture of two types of hardening agents, i.e., TDI and MDI, with a ratio of MDI to TDI (MDI/TDI) of 4, was used to harden the polyol emersion so that polyurethane particles 31 were produced. The polyurethane particles 31 were dispersed in silicone oil and thus the ERF of Example 1 was produced.

In each of Examples 2 to 5, ERF was produced in the same way as in the Example 1 except that pMDI was used in place of MDI in the Example 1 and the MDI/TDI and the hard segment ratio were each different. The MDI/TDI and the hard segment ratio in each of Examples 1 to 5 are shown in Table 1 as described later.

### Production of Electro-Rheological Fluids of Comparative Examples 1 to 6

In each of comparative examples 1 to 6, ERF was produced in the same way as in the Examples 1 to 5 except that the MDI/TDI and the hard segment ratio were each different. An isocyanate type, MDI/TDI, and a hard segment ratio in each of the comparative examples 1 to 6 are shown in later-described Table 1.

### Evaluation of ERF

An electro-rheological effect (ER effect), glass-transition temperature, heat resistance, and electric resistance were evaluated under the following condition. Glass-transition temperature (Tg) of a sample produced in each of the Examples 1 to 5 and the comparative examples 1 to 6 was measured using differential scanning calorimetry (DSC). The ERF in a liquid state of each of the Examples and the comparative examples was directly used as a measurement sample. Since the polyurethane particles contained in the ERF essentially have the glass-transition temperature (Tg), the particles are considered to be desirably separated for measurement. In the invention, however, Tg was measured in the liquid state for the following reasons.
(1) To check change in properties in actual use environment.
(2) To eliminate variations due to manual operation such as particle separation.

Measured glass-transition temperatures are shown in later-described Table 1.

The electro-rheological effect and current density of each of the Examples 1 to 5 and the comparative examples 1 to 6 were measured by a rotational viscometer method using a rheometer (from Anton paar, MCR 502). Yield stress was determined using a flat plate 25 mm in diameter under a condition of a measurement temperature range of 20° C. and applied electric field intensity of 5 kV/mm. In this rheometer, shear rate was defined to have a value calculated by ⅔ × (ω × R) / H, and shear stress was defined to have a value calculated by 4/3 × M / (π × R3). It is to be noted that ω represents angular velocity, R represents plate radius, H represents interplate distance, and M represents motor torque. Since results of the measurement revealed that the shear stress had a maximum value against the shear rate, the maximum value was defined as the yield stress in the invention.

For evaluation of heat resistance, the ER effect was measured before and after heat loading, and change rate of the ER effect (yield stress) after the heat loading was calculated according to the following formula.

$$\begin{matrix}\left(\text{Change rate of yield stress after heat loading}\right) = \\ \left(\begin{matrix}\text{yield stress before heat loading} - \\ \text{yield stress after heat loading}\end{matrix}\right) / \\ \left(\text{yield stress before heat loading}\right) \times 100\end{matrix}$$

Change rate of yield stress of 15% or less probably leads to small influence on ride quality of a vehicle. Hence, the decreasing rate of yield stress after the heat loading was evaluated to be acceptable when the decreasing rate falls within a range from -15% to +15%.

Evaluation results of the Examples 1 to 5 and the comparative examples 2 to 6 are shown in Table 1.

Table 1

| | Isocyanate type (ratio between two types) | Ratio of isocyanate to polyol (%) | Hard segment ratio (%) | Glass transition temperature (°C) | Yield stress | Change rate of yield stress after heat loading (%) | Electric resistance of ERF (Ω·cm) |
|---|---|---|---|---|---|---|---|
| Example 1 | MDI/TDI (4) | 36.4 | 34.0 | -24.2 | 1.5 | -4.4 | 10¹⁰ to 10¹³ |
| Example 2 | pMDI/TDI (0.60) | 35.2 | 30.0 | -23.9 | 1.5 | 35.6 | |
| Example 3 | pMDI/TDI | 30.0 | 21.3 | -23.7 | 1.9 | 34.6 | |
| | (0.15) | | | | | | |
| Example 4 | pMDI/TDI (0.15) | 30.2 | 23.7 | -25.0 | 2.7 | -9.4 | |
| Example 5 | pMDI/TDI (0.13) | 28.0 | 13.0 | -31.9 | 4.5 | -14.9 | |
| Comparative Example 1 | TDI | 26.7 | 10.4 | -31 | 3.4 | -45.6 | |
| Comparative Example 2 | MDI/TDI (1.5) | 27.8 | 12.2 | -25.3 | 1.1 | -25.8 | |
| Comparative Example 3 | MDI/TDI (0.67) | 27.0 | 11.2 | -26.0 | 2.5 | 36.3 | |
| Comparative Example 4 | MDI/TDI (0.25) | 27.0 | 10.8 | -28.1 | 2.6 | -33.7 | |
| Comparative Example 5 | pMDI/TDI (0.6) | 21.7 | 10.2 | -37 | 3.9 | -37.9 | |
| Comparative Example 6 | pMDI/TDI (0.13) | 20.1 | 9.4 | -37 | 5.0 | -51.2 | |

As shown in Table 1, the Examples 1 to 5 within the scope of the invention each had a high ER effect and high heat resistance.

As described hereinbefore, according to the invention, it is possible to provide an electro-rheological fluid and a cylinder device, which each have sufficient heat resistance while exhibiting a large ER effect.

The invention should not be limited to the above-described Examples, and includes various modifications and alterations thereof. For example, the Examples have been described in detail merely to clearly explain the invention, and the invention is not necessarily limited to an embodiment having all the described configurations. In addition, part of a configuration of one Example can be substituted for a configuration of another Example, and a configuration of one Example can be added to a configuration of another Example. Furthermore, a configuration of one Example can be added to, eliminated from, or substituted for part of a configuration of another Example.

### LIST OF REFERENCE SIGNS

1 Cylinder device, 2 base shell, 2a upper end plate, 3 outer casing, 3a outer electrode, 4 inner casing (cylinder), 4a inner electrode, 5 horizontal hole, 6 rod, 7 oil sheal, 8 electro-rheological fluid, 9 piston, 9L lower piston room, 9U upper piston room, 9h through-hole, 10 body, 10h through-hole, 11 controller, 13 inert gas, 20 voltage application unit, 22, 23, 24 channel, 25 acceleration sensor, 26 water absorbing mechanism, 300 electro-rheological fluid, 30 fluid, 31 polyurethane particle, 40 soft segment, 41 hard segment, 42 ion.

1. An electro-rheological fluid, comprising:
a fluid; and
polyurethane particles containing metal ion,
wherein the polyurethane particles are each composed of polyol and two or more types of isocyanates, and
a hard segment ratio of the polyurethane particle is 13 to 34%.

2. The electro-rheological fluid according to claim 1, wherein the polyol is polyether polyol, and the isocyanate is aromatic isocyanate or modified isocyanate.

3. The electro-rheological fluid according to claim 1, wherein a mass ratio of the polyol to the isocyanate is 28 to 36.4%.

4. The electro-rheological fluid according to claim 1, wherein the electro-rheological fluid has a volume resistivity of 1.0 × 10¹⁰ to 1.0 × 10¹³ Ω • cm.

5. The electro-rheological fluid according to claim 1, wherein the isocyanate includes toluene diisocyanate and diphenylmethane diisocyanate, and a mass ratio of the diphenylmethane diisocyanate to the toluene diisocyanate (diphenylmethane diisocyanate / toluene diisocyanate) is 0.13 to 4.

6. The electro-rheological fluid according to claim 5, wherein the mass ratio of the diphenylmethane diisocyanate to the toluene diisocyanate (diphenylmethane diisocyanate / toluene diisocyanate) is 0.13 to 0.6.

7. The electro-rheological fluid according to claim 5, wherein the diphenylmethane diisocyanate includes polymeric diphenylmethane diisocyanate.

8. A cylinder device, comprising:
a piston rod; an inner casing in which the piston rod is inserted; an electro-rheological fluid provided between the piston rod and the inner casing; and a voltage application unit that applies a voltage to the electro-rheological fluid,
wherein the electro-rheological fluid includes a fluid and polyurethane particles containing metal ion,
the polyurethane particles are each composed of polyol and two or more types of isocyanates, and
a hard segment ratio of the polyurethane particle is 13 to 34%.

9. The cylinder device according to claim 8, wherein the polyol is polyether polyol, and the isocyanate is aromatic isocyanate or modified isocyanate.

10. The cylinder device according to claim 8, wherein a mass ratio of the polyol to the isocyanate is 28 to 36.4%.

11. The cylinder device according to claim 8, wherein the electro-rheological fluid has a volume resistivity of 1.0 × 10¹⁰ to 1.0 × 10¹³ Ω • cm.

12. The cylinder device according to claim 8, wherein the isocyanate includes toluene diisocyanate and diphenylmethane diisocyanate, and a mass ratio of the diphenylmethane diisocyanate to the toluene diisocyanate (diphenylmethane diisocyanate / toluene diisocyanate) is 0.13 to 4.

13. The cylinder device according to claim 12, wherein the mass ratio of the diphenylmethane diisocyanate to the toluene diisocyanate (diphenylmethane diisocyanate / toluene diisocyanate) is 0.13 to 0.6.

14. The cylinder device according to claim 12, wherein the diphenylmethane diisocyanate includes polymeric diphenylmethane diisocyanate.
